(19) United States
(12) Patent Application Publication
(10) Pub. No.: US 2008/0134063 A1
(43) Pub. Date: Jun. 5, 2008

(54) SYSTEM AND METHOD FOR DISPLAYING DYNAMIC INFORMATION CONTENT IN A SCREEN SAVER OF A MOBILE COMMUNICATION DEVICE

(75) Inventor: Ben VOLACH, Sterling, VA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: NeuStar, Inc., Sterling, VA (US)

(21) Appl. No.: 11/844,987

(22) Filed: Aug. 24, 2007

Related U.S. Application Data
(60) Provisional application No. 60/839,704, filed on Aug. 24, 2006.

(51) Int. Cl. G06F 3/00

(52) U.S. Cl. 715/762

(57) ABSTRACT

A system and method are disclosed for displaying dynamic information content in a screen saver of a mobile communication device. The system includes a presence-enhanced mobile communication device. The mobile communication device includes a graphical user interface (GUI) display module. The GUI display module is configured to display information content to the user. The mobile communication device includes a presence information module. The presence information module is configured to manage dynamic presence information associated with the user. The mobile communication device includes a presence information screen saver module in communication with the presence information module. The presence information screen saver module is configured to display the dynamic presence information in a screen saver displayed via the GUI display module of the mobile communication device.

The present application claims priority under 35 U.S.C. § 119(e) to U.S. Provisional Application No. 60/839,704, filed on Aug. 24, 2006, the entire contents of which are hereby incorporated by reference herein.

### BACKGROUND

1. Field of the Invention

The present invention relates to mobile communication systems. More particularly, the present invention relates to a system and method for displaying dynamic information content in a screen saver of a mobile communication device.

2. Background Information

A conventional mobile or handheld communication device includes a display or other screen for displaying, for example, a graphical user interface (GUI) through which the user interacts with the device. Such mobile devices can provide a low-battery consumption mode, a screen saver mode, a limited-content display mode, or some combination thereof when the screen is not being used to provide the full range of capabilities offered by the mobile device. In particular, mobile communication devices can provide a screen saver mode for various reasons. For example, a screen saver can be used to protect the screen from image “burning,” as well as saving resource consumption (e.g., display operation) that are pertinent to mobile devices with limited batter power.

Mobile communication devices can also provide presence-enhanced contact lists and other like presence information that are accessible from the input or output mechanism of the mobile device (e.g., keys, menus, screen, or the like). However, when the device is idle or otherwise switches to the screen saver mode, the presence information is not presented to or otherwise accessible by the user. Additionally, various types of content sources can also provide information to the mobile device that can be displayed to the user. Such information can be accessed by the user utilizing the input or output mechanism of the mobile communication device. However, the information is not accessible by the user when the mobile device switches to screen saver mode.

### SUMMARY OF THE INVENTION

A system and method are disclosed for displaying dynamic information content in a screen saver of a mobile communication device. In accordance with exemplary embodiments of the present invention, according to a first aspect of the present invention, a system for a system for displaying information to a user includes a presence-enhanced mobile communication device. The mobile communication device includes a graphical user interface (GUI) display module. The GUI display module is configured to display information content to the user on a display screen of the mobile communication device. The mobile communication device includes a presence information module. The presence information module is configured to manage dynamic presence information associated with the user. The mobile communication device includes a presence information screen saver module in communication with the presence information module. The presence information screen saver module is configured to display the dynamic presence information in a screen saver displayed via the GUI display module.

According to the first aspect, the mobile communication device can include a presence information preference management module in communication with the presence information module. The presence information preference management module can be configured to manage user preferences for displaying the dynamic presence information in the screen saver. The mobile communication device can include a presence information storage module in communication with the presence information module. The presence information storage module can be configured to store the dynamic presence information. The mobile communication device can include a presence information communication module in communication with the presence information module. The presence information communication module can be configured to communicate the dynamic presence information.

According to the first aspect, the mobile communication device can be configured to receive an information-query transaction from the user in response to the dynamic presence information displayed in the screen saver. The information-query transaction can be configured to cause the presence information screen saver module to cease displaying the screen saver. The information-query transaction can be configured to cause the GUI display module to display information content at a network address associated with the dynamic presence information. The information-query transaction can comprise a predetermined key sequence entered into an information input module of the mobile communication device. The system can include a presence information server in communication with the mobile communication device. The presence information server can be configured to provide the dynamic presence information to the presence information module.

According to a second aspect of the present invention, a mobile communication handset includes a display screen. The display screen is adapted to display information to a user of the mobile communication handset. The mobile communication handset includes mobile client application structure adapted to execute on the mobile communication handset. The mobile client application structure is in communication with the display screen. The mobile client application structure includes dynamic information content management structure. The dynamic information content management structure is adapted to manage dynamic information content associated with the user. The mobile client application structure includes dynamic information content screen saver structure in communication with the dynamic information content management structure. The dynamic information content screen saver structure is adapted to display the dynamic information content in a screen saver displayed on display screen.

According to the second aspect, the mobile communication handset can include information storage structure in communication with the mobile client application structure. The information storage structure can be configured to store the dynamic information content. The mobile communication handset can include information communication structure in communication with the mobile client application structure. The information communication structure can be configured to communicate the dynamic information content. The mobile communication handset can be in communication with a dynamic information content server. The dynamic information content server can be configured to communicate the dynamic information content to the mobile communication handset. The dynamic information content server can include dynamic information content preference management structure. The dynamic information content preference management structure can be configured to manage user preferences for displaying the dynamic information content in the screen saver of mobile communication handsets.

According to the second aspect, the mobile communication handset can be configured to receive an information-query transaction from the user in response to the dynamic information content displayed in the screen saver. The information-query transaction can be configured to cause the dynamic information content screen saver structure to cease displaying the screen saver. The information-query transaction can be configured to cause the display on the display screen of information content at a network address associated with the dynamic information content. The mobile communication handset can include information input structure in communication with the mobile client application structure. The information-query transaction can comprise a predetermined key sequence entered into the information input structure.

According to a third aspect of the present invention, a method of displaying information to a user includes the steps of: receiving dynamic presence information associated with the user at a mobile communication device; and displaying the dynamic presence information in a screen saver on a display screen of the mobile communication device.

According to the third aspect, the method can include one or more of the following steps: managing the dynamic presence information associated with the user; managing user preferences for displaying the dynamic presence information in the screen saver; storing dynamic presence information for display in the screen saver; and communicating the dynamic presence information for display in the screen saver. The method can include the step of receiving an information-query transaction from the user on the mobile communication device in response to the dynamic presence information displayed in the screen saver. The information-query transaction can be configured to cause the screen saver to cease being displayed. The method can include the step of: displaying information content at a network address associated with the dynamic presence information. The information-query transaction can comprise a predetermined key sequence entered into the mobile communication device.

According to a fourth aspect of the present invention, a method of displaying dynamic information content to a user on a mobile communication handset includes the steps of: receiving the dynamic information content associated with the user at the mobile communication handset; modifying the dynamic information content in accordance with display requirements of the display screen of the mobile communication handset; and displaying the modified dynamic information content in a screen saver on the display screen. Additionally, the modifying step can include the step of: wherein step (b) comprises the step of: modifying the dynamic information content in accordance with user preferences.

According to a fifth aspect of the present invention, a system for displaying information to a user includes a presence-enhanced mobile communication device. The mobile communication device includes a GUI display. The GUI display is configured to display information content to the user on the mobile communication device. The mobile communication device includes means for managing presence information. The presence information managing means is configured to manage dynamic presence information associated with the user. The mobile communication device includes means for displaying a presence information screen saver in communication with the presence information managing means. The presence information screen saver displaying means is configured to display the dynamic presence information in a screen saver displayed via the GUI display.

According to the fifth aspect, the mobile communication device can include means for managing presence information preferences in communication with the presence information managing means. The presence information preference managing means can be configured to manage user preferences for displaying the dynamic presence information in the screen saver. The mobile communication device can include means for storing presence information in communication with the presence information managing means. The presence information storing means can be configured to store the dynamic presence information. The mobile communication device can include means for communicating presence information in communication with the presence information managing means. The presence information communicating means can be configured to communicate the dynamic presence information.

According to the fifth aspect, the mobile communication device can be configured to receive an information-query transaction from the user in response to the dynamic presence information displayed in the screen saver. The information-query transaction can be configured to cause the presence information screen saver displaying means to cease displaying the screen saver. The information-query transaction can be configured to cause the GUI display to display information content at a network address associated with the dynamic presence information. The information-query transaction can comprise a predetermined key sequence entered into a means for inputting information of the mobile communication device. A presence information server can be in communication with the mobile communication device. The presence information server can be configured to provide the dynamic presence information to the presence information managing means.

According to a sixth aspect of the present invention, a mobile communication handset includes a display screen. The display screen is adapted to display information to a user of the mobile communication handset. The mobile communication handset includes a mobile client application module adapted to execute on the mobile communication handset. The mobile client application module is in communication with the display screen. The mobile client application module includes means for managing dynamic information content. The dynamic information content managing means is adapted to manage dynamic information content associated with the user. The mobile client application module includes means for displaying dynamic information content in a screen saver in communication with the dynamic information content managing means. The dynamic information content screen saver displaying means is adapted to display the dynamic information content in a screen saver displayed on display screen.

According to the sixth aspect, the mobile communication handset can include means for storing information in communication with the mobile client application module. The information storing means can be configured to store the dynamic information content. The mobile communication handset can include means for communicating information in communication with the mobile client application module. The information communicating means can be configured to communicate the dynamic information content. The mobile communication handset can be in communication with a dynamic information content server. The dynamic information content server can be configured to communicate the dynamic information content to the mobile communication handset. The dynamic information content server can include means for managing dynamic information content preferences. The dynamic information content preference managing means can be configured to manage user preferences for displaying the dynamic information content in the screen saver of mobile communication handsets.

According to the sixth aspect, the mobile communication handset can be configured to receive an information-query transaction from the user in response to the dynamic information content displayed in the screen saver. The information-query transaction can be configured to cause the dynamic information content screen saver displaying means to cease displaying the screen saver. The information-query transaction can be configured to cause the display on the display screen of information content at a network address associated with the dynamic information content. The mobile communication handset can include means for inputting information in communication with the mobile client application module. The information-query transaction can comprise a predetermined key sequence entered into the information inputting means.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for displaying information to a user, in accordance with an exemplary embodiment of the present invention.

FIG. 2 is a block diagram illustrating a mobile communication handset, in accordance with an alternative exemplary embodiment of the present invention.

FIG. 3 is a flowchart illustrating steps for displaying information to a user, in accordance with an exemplary embodiment of the present invention

FIG. 4 is a flowchart illustrating steps for displaying dynamic information content to a user on a mobile communication handset, in accordance with an exemplary embodiment of the present invention.

### DETAILED DESCRIPTION OF THE PREFERRED EMBODIMENTS

Exemplary embodiments of the present invention are directed to a system and method for displaying dynamic information content in a screen saver of a mobile communication device. According to exemplary embodiments, the screen saver of a mobile or handheld communication device can display dynamic presence or other information according to the user's preferences and settings. The present invention can provide critical information that is always accessible to the user, such as, for example, how many information contacts are online, whether a specific information contact is trying to initiate an instant messaging (IM) session, and other like dynamic information. The present invention also provides a non-intrusive content delivery platform that can be used by the network operator to offer various dynamic content to the user, such as, for example, updated weather reports from a chosen location, a listing of current films at the user's favorite cinema, and other like dynamic content. Thus, the dynamic information content that can be presented to the user through the screen saver of the mobile communication device can include any suitable type of information content that can be supplied from various content services, including, but not limited to, weather, sports, auctions, news, television, astrology, traffic, music, location-based services, and the like.

According to an exemplary embodiment, the trigger for the information presented in the screen saver can be based on notification from pre-subscribed information contacts, such as, for example, a state change for those contacts that is reflected in the screen saver. Users can select their content sources of choice, receive constant updates, extract further information on specific items of interest, receive instant answers, and can interact with or as a result of the information in other like manners. In addition, multiple content sources can be offered to the user that cover a variety of defined topics, including, for example, various information and services available to the user. Thus, the present invention can utilize the idle time of the mobile device to provide the user with personalized, dynamic, always-accessible information, regardless of the internal modes of the mobile device.

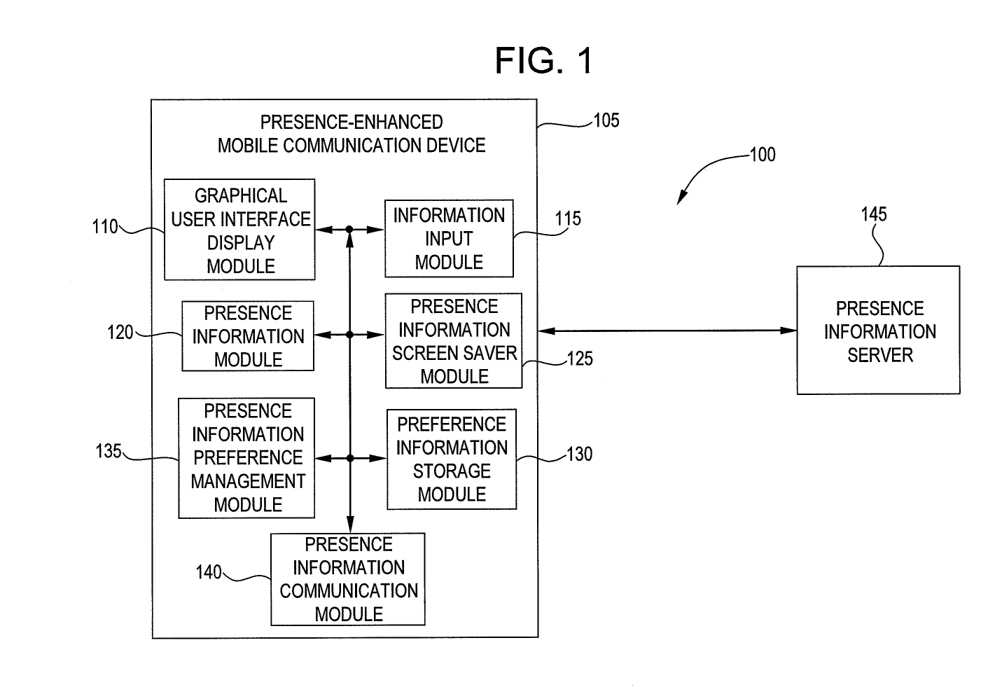

These and other aspects and embodiments of the present invention will now be described in greater detail. FIG. 1 is a block diagram illustrating a system 100 for displaying information to a user, in accordance with an exemplary embodiment of the present invention. The system 100 includes a presence-enhanced handheld or mobile communication device or handset 105. The system 100 can support any suitable number of mobile communication devices 105 (e.g., mobile communication device 1, mobile communication device 2, mobile communication device 3, . . . , mobile communication device N, where N is any appropriate number). Each mobile communication device 105 can be comprised of any suitable type of mobile, portable, handheld, or otherwise wireless module, device, or handset (e.g., cellular telephone, personal digital assistant (PDA), or other like mobile or wireless communication endpoint) that is capable of communicating messages, information or other information content using any appropriate type of mobile or wireless messaging service or communication mechanism. For example, such mobile communication devices 105 can communicate via a suitable mobile network that can be operated or otherwise managed by any appropriate type of mobile network operator, mobile virtual network operator, wireless service provider, wireless carrier, mobile phone operator, or cellular company or organization.

According to one exemplary embodiment, the mobile communication device 105 is configured to operate or otherwise interact with a suitable presence information communication service and system. However, those of ordinary skill in the art will recognize that exemplary embodiments of the present invention can be used with any appropriate type of wireless messaging or communication system (e.g., e-mail, instant messaging (IM), short message service (SMS), enhanced messaging service (EMS), multimedia messaging service (MMS), or the like). In addition, those of ordinary skill in the art will also recognize that exemplary embodiments of the present invention can be used with any suitable type of wired and/or wireless communication device (e.g., a computer or PC that is adapted to communicate via a network, such as an intranet or internet, using a suitable network connection).

The mobile communication device 105 includes a graphical user interface (GUI) display module 110. The GUI display module 110 is configured or otherwise adapted to display information content to the user on a display screen of the mobile communication device 105. A GUI is a type of user interface that can display graphical and/or textual information to the user and allow the user to interact with the mobile communication device 105. The GUI display module 110 can include (or be in communication with) a suitable display screen or monitor on the mobile communication device 105 that is capable of displaying such graphical and/or textual content to the user. In other words, the GUI can employ graphical icons, visual indicators, or other such graphical elements, along with text labels and/or text navigation to represent and display graphical and/or textual information and actions available to a user, and all such information can be displayed to the user via the GUI display module 105. Accordingly, the GUI display module 110 can be configured to display or otherwise present any suitable arrangement or configuration of graphical and/or textual elements or other like information content on the display screen of the mobile communication device 105.

User interaction with the GUI display module 110 and the mobile communication device 105 can be performed through direct manipulation of the graphical elements displayed within the GUI or through an input mechanism of the mobile communication device 105. Accordingly, the mobile communication device 105 can include an information input module 115 that provides an input mechanism to allow the user to interact with the GUI display module 110 and the mobile communication device 105. For example, the information input module 115 can comprise a keypad or the like to allow the user to select corresponding keys or buttons on the mobile communication device 105. Additionally or alternatively, the information input mechanism 115 can allow the user to interact with the GUI display module 110 and the mobile communication device 105 using a suitable pointer device, such as a stylus or human finger (e.g., for touch-sensitive display screens). The information input module 115 can additionally or alternatively comprise a suitable speech or voice recognition mechanism that is capable of allowing the user to interact with the GUI display module 110 and the mobile communication device 105 through voice commands.

The mobile communication device 105 includes a presence information module 120. The presence information module 120 is configured to manage dynamic presence information associated with the user. The presence information module 120 can receive the dynamic presence information from one or more remote sources. If necessary, the presence information module 120 can also process that information in a suitable manner so that such information can be displayed properly in the screen saver of the mobile communication device 105. For example, the presence information module 120 can re-format or perform suitable content transforms on the dynamic presence information to ensure that such information is capable of being displayed in a screen saver on the display screen of the mobile communication device 105. For purposes of illustration and not limitation, for graphical or pictorial content, the presence information module 120 can decrease the resolution or scale images to ensure that the images fit the display screen or are compatible with the resolution supported by the display screen. The presence information module 120 can also manage the dynamic presence information in accordance with preferences or settings established by the user of the mobile communication device 105. For example, the user can specify that any video information is to be displayed as a series of still images, and the presence information module 120 can process such dynamic presence information in an appropriate manner to meet the user's settings.

As used herein, “dynamic presence information” can comprise any suitable type of information content can be displayed or otherwise presented to the user and updated in real-time or near real-time. For example, the dynamic presence information can comprise various types of presence information that conveys the ability and willingness of a potential communication partner or contact to communicate. For example, the dynamic presence information can comprise critical information that is accessible to the user, such as, for example, how many information or communication contacts are online, whether a specific information or communication contact is trying to initiate an IM session, and other like presence information. However, the dynamic presence information can comprise any suitable type of dynamic information content that can be provided to the user, such as, for example, updated weather reports from a chosen location, a listing of current films at the user's favorite cinema, and other like dynamic content. Thus, the dynamic presence information can include any suitable type of textual, graphical, video, image, pictorial, sound, voice, aural, multimedia or other like information content that can be supplied from any appropriate type of content service, including, but not limited to, weather, sports, auctions, news, television, astrology, traffic, music, location-based services, and other like dynamic information. Such dynamic presence information can be provided to the user from one or more content sources, depending on the needs and preferences of the user.

The mobile communication device 105 includes a presence information screen saver module 125. The presence information screen saver module 125 is configured to display the dynamic presence information in a screen saver displayed via the GUI display module 110 of the mobile communication device 105. A screen saver is a software program designed to conserve the image quality of a display by preventing image “burn in” on the display when a device is not in use. The screen saver can also provide a low-power mode that the device is not being used. The screen saver can blank the display screen, or fill the display screen with moving images or patterns, so that the same image is not displayed on the screen for long periods of time. Accordingly, the presence information screen saver module 125 can provide such a screen saver for the mobile communication device 105. The presence information screen saver module 125 is configured to incorporate the dynamic presence information received and managed by the presence information module 120 into the screen saver of the mobile communication device 105 so that such information can be displayed to the user when the mobile communication device 105 is not being used (e.g., enters a low-power mode during periods of inactivity or is otherwise idle). For example, the presence information screen saver module 125 can display the dynamic presence information in a portion of the display screen and shift the position of such information around the display screen at regular intervals (e.g., every few seconds). Alternatively, the presence information screen saver module 125 can display the dynamic presence information in the entirety of the display screen so that the entire screen saver can change at regular intervals. To display such dynamic presence information, the presence information screen saver module 125 can interact with the screen saver provided by the operating software of the mobile communication device 105, or provide its own screen saver for use by the mobile communication device 105.

The user of the mobile communication device 105 can select any suitable number of content sources from which to receive such dynamic presence information so that the user can receive constant or substantially constant updates to such information, receive instant or substantially instant answers to queries, extract further information on specific items of interest, or the like. For example, the screen saver displayed by the presence information screen saver module 125 can be used to present music or other media that was recently used by the user or the information contacts associated with the user. Additionally, local aggregated presence information can be presented to the user in the screen saver, such as, for example, the number of information contacts that are online, the current (remote) user initiating a communication session with the (local) user, presence information (e.g., location) of selected information contacts, and the like. In addition, weather information at the user's current or predefined location can be provided to the user through the screen saver, including weather reports (e.g., text and image) or the like. Auction bids can also be displayed to the user through the screen saver of the mobile communication device 105, such as a picture of the product on which a bid has been placed and text indicating the current bid price. In addition, the network operator that provides the mobile communication services to the user can offer various dynamic presence information to the user through the screen saver displayed by the presence information screen saver module 125, such as, for example, updated weather reports from a chosen location, current films playing at the user's favorite cinema, or other like information. Any and all such dynamic presence information can be presented or otherwise displayed to the user through the screen saver of the mobile device via the presence information screen saver module 125.

Any suitable type of trigger or event can be used to update the dynamic presence information displayed in the screen saver by the presence information screen saver module 125. For example, the trigger for the information presented in the screen saver can be based on notifications from pre-subscribed information contacts, such as, for example, a state change for those contacts that is reflected in the screen saver. Alternatively, the presence information screen saver module 125 can update such information in the screen saver at periodic intervals, for example, according to preferences or settings established by the user. However, the presence information screen saver module 125 can update the dynamic presence information displayed in the screen saver whenever such information changes or is otherwise updated.

The presence information screen saver module 125 can launch the screen saver automatically according to default or configured behavior of the mobile communication device 105. For example, the screen saver can be activated after waiting a specified amount of time after the last keystroke or other user interaction with the mobile communication device 105. In other words, the mobile device can be allowed to become idle, to enter a low-power mode, or otherwise become inactive (although still powered on) such that the display screen is not being used to provide the full range of capabilities offered by the mobile communication device 105. Alternatively, the presence information screen saver module 125 can launch the screen saver upon manual activation initiated by the user (e.g., upon pressing one or more keys, closing the cover of a flip-style cellular phone, or other like action or event). The presence information screen saver module 125 can keep the screen saver active until, for example, the user presses a key or otherwise interacts with the mobile communication device 105 (e.g., via the information input module 115), or after a predetermined interval of time. Once deactivated by a suitable action or event or after a specified period of time, the presence information screen saver module 125 can close, deactivate, or otherwise dismiss the screen saver to restore the former screen contents. The user can then continue to use, work or otherwise interact with the mobile communication device 105.

According to an exemplary embodiment, the user can initiate an informational-query transaction in response to a content item displayed on the screen saver of the mobile device by presence information screen saver module 125. In other words, the mobile communication device 125 can be configured to receive an information-query transaction from the user in response to the dynamic presence information displayed in the screen saver. For example, the user can press a designated key or sequence of keys or buttons on the mobile communication device 105. Such an informational-query can be specific per content service, and can apply to the content item that is currently being presented to the user via the screen saver. Upon pressing the designated key(s) on the mobile communication device 105, the presence information screen saver module 125 can be configured to cause a suitable internet or web browser residing in the operating software of the mobile communication device 105 to launch to a predetermined network address (e.g., URL) that is associated with the dynamic presence information being displayed in the screen saver. For example, the presence information screen saver module 125 can send an appropriate signal, command, or other request to the operating system software of the mobile communication device 105 to launch the browser at the specified address. The predetermined network address can be provided along with the dynamic presence information, and such an address can be supplied to the presence information screen saver module 125 by the presence information module 120. Launching such a browser will also cause the presence information screen saver module 125 to move the screen saver to the background or otherwise close, deactivate, or dismiss the screen saver. Thus, the information-query transaction can be configured to cause the presence information screen saver module 125 to cease displaying the screen saver. For example, the information-query transaction can comprise a predetermined key sequence entered into the information input module 115. The information-query transaction is further configured to cause the GUI display module 110 to display information content at the network address associated with the dynamic presence information.

For purposes of illustration and not limitation, the presence information screen saver module 125 can present the current weather at the user's location in the screen saver. Upon pressing the designated key or key sequence on the mobile communication device 105, the screen saver can be closed, and the user can be presented with weather forecast information in the browser displayed via the GUI display module 110. For example, the presence information screen saver module 125 can display the user's current auction bid on a certain product. Upon pressing the designated key or key sequence, the screen saver can be moved to the background, and the user can be presented with further information on the product that was displayed in the screen saver. Any suitable additional information can be presented to the user in response to a query based on the dynamic presence information displayed in the screen saver according to exemplary embodiments.

The mobile communication device 105 can include a presence information database or storage module 130. The presence information storage module 130 can be configured to store the dynamic presence information received and managed by the presence information module. However, the presence information storage module 130 can be used to store any other suitable information used or maintained by the mobile communication device 105. The presence information storage module 130 can be comprised of any suitable type of computer-readable or other computer storage medium capable of storing information in electrical, electronic, or any other suitable form.

The mobile communication device 105 can include a presence information preference management module 135. The presence information preference management module 135 can be configured to manage user preferences for displaying the dynamic presence information in the screen saver. Any suitable preferences or settings can be managed by the presence information preference management module 135, and any such preference information can be stored or otherwise maintained in, for example, the presence information storage module 130 with which the presence information preference management module 135 can be in communication. For purposes of illustration and not limitation, the user can specify a setting that the screen saver is to be activated after 30 seconds (or other suitable interval of time) of inactivity. The user can also specify preferences for the type and nature of the dynamic presence information presented to the user in the screen saver. In other words, the presence information preference management module 135 can be used by the user to personalize or otherwise tailor the dynamic presence information that the user desires to receive.

The presence information preference management module 135 can also be used to manage preferences from other entities that use or are otherwise associated with the system 100, such as one or more communication service operators. Such operators can establish appropriate preferences or policies that are applicable to individual users or groups of users, all of which can be managed and maintained according to exemplary embodiments. For example, an operator can establish a preference, rule, or policy that the presence information screen saver module 125 is to display disaster or emergency alerts or warnings or other critical news information to all users in a given area upon activation of the screen saver when such alerts or warnings are issued. Additionally or alternatively, the operator can create a preference that if a user does not specify any dynamic presence information for display in the screen saver, then advertisements or other marketing information is to be displayed to the user upon launching of the screen saver. Alternatively, the operator can specify that advertisements and marketing content are to be displayed to all users for a short period of time before the dynamic presence information desired by the user is displayed in the screen saver. Those of ordinary skill in the art will recognize that the nature and types of dynamic presence information displayed in the screen saver of the mobile communication device 105 by the presence information screen saver module 125 will depend on many factors, including, but not limited to, operator policies and preferences, user policies and preferences, and other like factors.

The mobile communication device 105 can include a presence information communication module 140. The presence information communication module 140 can be configured to communicate the dynamic presence information managed by the presence information module 120 and displayed in the screen saver by the presence information screen saver module 130. However, each of the modules of the mobile communication device 105 can use the presence information communication module 140 to transmit and receive any suitable type of information used by and available to the mobile communication device 105. The presence information communication module 140 can be adapted to use any suitable type of wireless communication link, connection, or medium that uses an appropriate form of wireless communication mechanism, protocol, or technique to communicate with other entities. For example, the presence information communication module 140 can be used to communicate with different content sources using different communication protocols or services (e.g., by identifying the protocol or service being used by the entity). In other words, the presence information communication module 140 can be configured to use any or all of a plurality of communication access protocols to support various suitable types of networks, security settings, communication environments, and the like.

The system 100 can include additional modules, devices, and other components to facilitate the presentation of the dynamic presence information to the user via the screen saver on the mobile communication device 105. For example, the system 100 can include one or more presence information servers 145. The presence information servers 145 are each configured to provide the dynamic presence information to the presence information module 120 of the mobile communication device 105. Each presence information server 145 can be in communication with the mobile communication device 105 and other external sources and systems to facilitate the communication of dynamic presence information to the mobile communication device 105. The number and type of such presence information servers 145 will depend on the type of communication services offered in each operator network, the information content sources available to supply dynamic presence information, and other like factors. For example, although each presence information server 145 can supply presence or other like information, the presence information servers 145 can comprise any suitable type of service enabler, such as, for example, an IM Service Center (e.g., an IM enabler), a Short Message Service Center (SMSC), or the like, or any other suitable type of information content source or server that is capable of providing dynamic presence or other like information to the mobile communication device 105.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the presence information servers 145 can be located extraterritorially to the United States (e.g., in Canada and/or in one or more other foreign countries). However, each or any mobile communication device 105 (including the GUI display module 110, the information input module 115, the presence information module 120, the presence information screen saver module 125, the presence information preference management module 135, the preference information storage module 130, and the presence information communication module 140) can be located within the United States, such that the control of the system 100 as a whole is exercised and beneficial use of the system 100 is obtained by the user within the United States.

Each of modules of the mobile communication device 105, including the GUI display module 110, the information input module 115, the presence information module 120, the presence information screen saver module 125, the presence information preference management module 135, the preference information storage module 130, and the presence information communication module 140, or any combination thereof, can be comprised of any suitable type of electrical or electronic component or device that is capable of performing the functions associated with the respective element. According to such an exemplary embodiment, each component or device can be in communication with another component or device using any appropriate type of electrical connection or communication link (e.g., wireless, wired, or a combination of both) that is capable of carrying such information. Alternatively, each of the modules of the mobile communication device 105 can be comprised of any combination of hardware, firmware and software that is capable of performing the functions associated with the respective module.

Alternatively, the mobile communication device 105 can be comprised of one or more microprocessors and associated memory(ies) that store the steps of a computer program to perform the functions of one or more of the modules of the mobile communication device 105. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of one or more of the modules of the mobile communication device 105. For example, the actual source code or object code of the computer program or other like structure can be stored in the memory.

The system 100 can include suitable additional modules as necessary to assist or augment the functionality of any or all of the modules of the mobile communication device 105. For example, the system 100 can include one or more database or storage modules that can be in communication with the mobile communication device 105 and/or the presence information servers 145. Such additional storage modules can be configured to store any suitable type of information generated or used by or with the system 100, including, for example, information on the mobile communication devices 105, dynamic presence information configuration information (e.g., policies or rules governing distribution and display of dynamic presence information to mobile communication devices 105), dynamic presence information, and other like information. Such storage modules can be comprised of any suitable type of computer-readable or other computer storage medium capable of storing information in electrical, electronic, or any other suitable form.

Alternative architectures or structures can be used to implement the various functions of the system 100 and the mobile communication device 105 as described herein. For example, functions from two or more modules can be implemented in a single module, or functions from one module can be distributed among several different modules. For example, the presence information preference management module 135 can form a component of the presence information module 120, such that the presence information module 120 is configured to perform the functionality of that (incorporated) module.

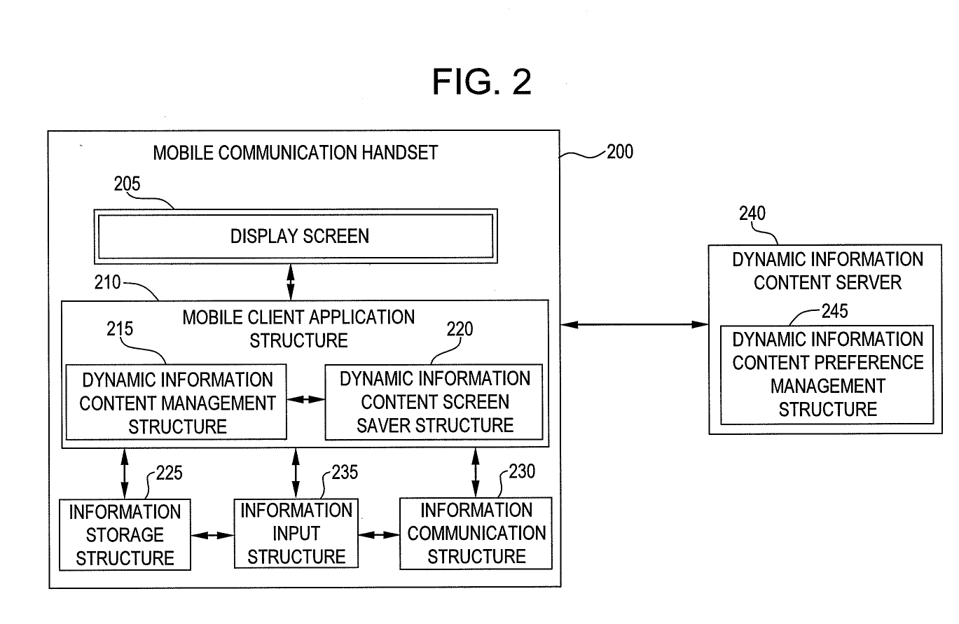

For purposes of illustration and not limitation, FIG. 2 is a block diagram illustrating a mobile communication handset 200, in accordance with an alternative exemplary embodiment of the present invention. The mobile communication handset 200 includes a display screen 205. The display screen 205 is adapted to display information to a user of the mobile communication handset 200. For example, the display screen 205 can comprise a suitable screen or monitor on the mobile communication handset 200 that is capable of displaying graphical and/or textual information content to the user.

The mobile communication handset 200 includes mobile client application structure 210 adapted to execute on the mobile communication handset 200. The mobile client application structure 210 is in communication with the display screen 205 and is capable of displaying or causing the display of information on the display screen 205. According to an exemplary embodiment, the mobile client application structure 210 can comprise the operating system software for running and operating the mobile communication handset 200. Other applications or modules can be configured to run within such an operating system environment to provide other various and suitable features and functionality for the mobile communication handset 200. According to an alternative exemplary embodiment, the mobile client application structure 210 can comprise an application or other software that runs within an operating system that is provided by and with the mobile communication handset 200. In such an alternative exemplary embodiment, the mobile client application structure 210 can comprise one or a collection of application modules that provide the functionality described herein, in addition to other application modules that may be running or otherwise executing within the operating system environment provided by or with the mobile communication handset 200. The actual implementation of the mobile client application structure 210 will depend on the type of mobile communication handset 200 and the functionality and features of such a device, and other like factors.

The mobile client application structure 210 includes dynamic information content management structure 215. The dynamic information content management structure 215 is adapted to manage the dynamic information content associated with the user (e.g., in a manner similar to that described previously for the presence information module 120). As discussed previously, the dynamic information content can include any suitable type of textual, graphical, video, image, pictorial, sound, voice, aural, multimedia or other like information content that can be supplied from any appropriate type of various content services, including, but not limited to, weather, sports, auctions, news, television, astrology, traffic, music, location-based services, and other like dynamic information, and such dynamic information content can be supplied to the user and updated in real-time or near real-time. The mobile client application structure 210 includes dynamic information content screen saver structure 220 in communication with the dynamic information content management structure 215. The dynamic information content screen saver structure 220 is adapted to display the dynamic information content in a screen saver displayed on the display screen 205 (e.g., in a manner similar to that described previously for the presence information screen saver module 125).

The mobile communication handset 200 can include information storage structure 225 in communication with the mobile client application structure 210. The information storage structure 225 can be configured to store the dynamic information content, as well as any other suitable type of information used by or associated with the mobile communication handset 200 (e.g., in a manner similar to that described previously for the presence information storage module 130). The mobile communication handset can also include information communication structure 230 in communication with the mobile client application structure 210. The information communication structure 230 can be configured to communicate the dynamic information content, as well as any other suitable type of information used by or associated with the mobile communication handset 200 (e.g., in a manner similar to that described previously for the presence information communication module 140).

As discussed previously, the mobile communication handset 200 can be configured to receive an information-query transaction from the user in response to the dynamic information content displayed in the screen saver. The information-query transaction can be configured to cause the dynamic information content screen saver structure 220 to cease displaying or otherwise close the screen saver. The information-query transaction can also be configured to cause the display, on the display screen 205, of information content at a network address associated with the dynamic information content (e.g., through a suitable web or other network browser available through the operating system software of the mobile communication handset 200). Accordingly, the mobile communication handset can include information input structure 235 in communication with the mobile client application structure 210 (e.g., similar to that described previously for the information input module 115). The information-query transaction can comprise, for example, a predetermined key or other input sequence entered into the information input structure 235.

The mobile communication handset 200 can be in communication with one or more dynamic information content servers 240. Each dynamic information content server 240 can be configured to communicate dynamic information content to the mobile communication handset 200 (e.g., in a manner similar to that described previously for the presence information server 145). To manage the user preferences and settings for each, any, or all mobile communication handsets 200, the dynamic information content server 240 can include dynamic information content preference management structure 245. The dynamic information content preference management structure 245 can be configured to manage user preferences for displaying the dynamic information content in the screen saver of mobile communication handsets 200 (e.g., in a manner similar to that described previously for the presence information preference management module 135). In other words, the preferences and other user settings for each mobile communication handset 200 can be uploaded, stored, and managed centrally by the dynamic information content preference management structure 245 of the dynamic information content server 240. Such centralized control can be in addition or alternative to any dynamic information content preference management structure that resides in each mobile communication handset 200 (e.g., in the mobile client application structure 210). Other alternative architectures or structures can be used to implement the various functions of the mobile communication device 105 and mobile communication handset 200 as described herein.

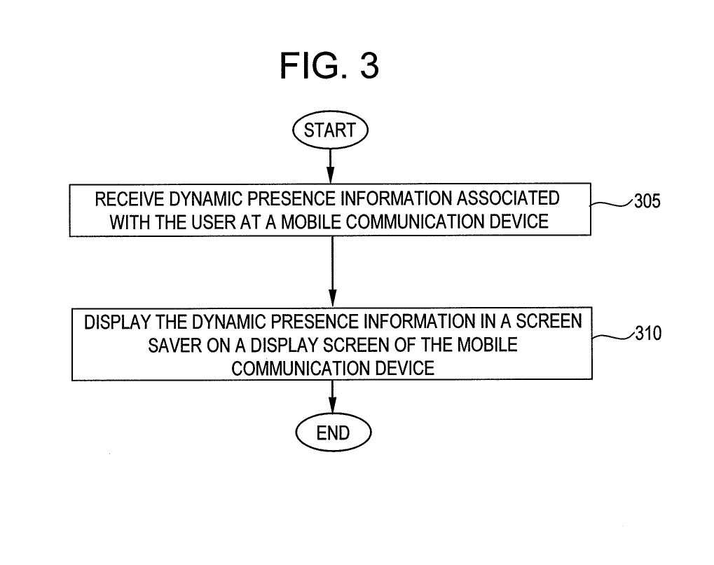

FIG. 3 is a flowchart illustrating steps for displaying information to a user, in accordance with an exemplary embodiment of the present invention. In step 305, dynamic presence information associated with the user is received at a mobile communication device. In step 310, the dynamic presence information is displayed in a screen saver on a display screen of the mobile communication device. The method can include one or more of the following steps: managing the dynamic presence information associated with the user; managing user preferences for displaying the dynamic presence information in the screen saver; storing dynamic presence information for display in the screen saver; and communicating the dynamic presence information for display in the screen saver. According to an exemplary embodiment, the method can include the step of receiving an information-query transaction from the user on the mobile communication device in response to the dynamic presence information displayed in the screen saver. The information-query transaction can be configured to cause the screen saver to cease being displayed. Accordingly, the method can include the step of displaying information content at a network address associated with the dynamic presence information. The information-query transaction can comprise, for example, a predetermined key sequence entered into the mobile communication device.

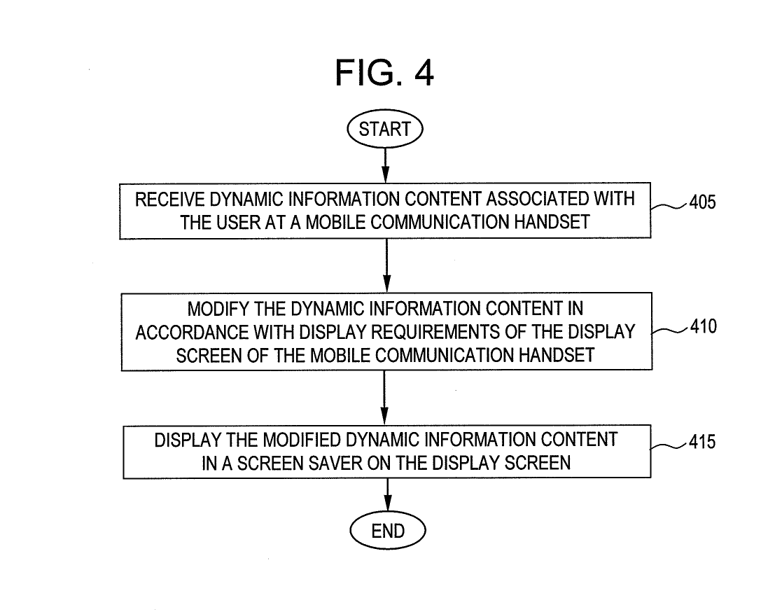

FIG. 4 is a flowchart illustrating steps for displaying dynamic information content to a user on a mobile communication handset, in accordance with an exemplary embodiment of the present invention. In step 405, the dynamic information content associated with the user is received at the mobile communication handset. In step 410, the dynamic information content is modified in accordance with display requirements of the display screen of the mobile communication handset. The dynamic information content can additionally or alternatively be modified in accordance with user preferences or settings, as discussed previously. In step 415, the modified dynamic information content is displayed in a screen saver on the display screen of the mobile communication handset.

Each, all or any combination of the steps of a computer program as illustrated in FIGS. 3 and 4 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any wireless device, system or process for communicating information. For example, exemplary embodiments can be used in presence- and IM-based communication systems, such as in mobile IM systems and the like, and/or communication systems that support rich or other multimedia content delivery.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for displaying information to a user, comprising:
a presence-enhanced mobile communication device,
wherein the mobile communication device comprises:
a graphical user interface (GUI) display module,
wherein the GUI display module is configured to display information content to the user on a display screen of the mobile communication device;
a presence information module,
wherein the presence information module is configured to manage dynamic presence information associated with the user; and
a presence information screen saver module in communication with the presence information module,
wherein the presence information screen saver module is configured to display the dynamic presence information in a screen saver displayed via the GUI display module.

2. The system of claim 1, wherein the mobile communication device comprises:
a presence information preference management module in communication with the presence information module,
wherein the presence information preference management module is configured to manage user preferences for displaying the dynamic presence information in the screen saver.

3. The system of claim 1, wherein the mobile communication device comprises:
a presence information storage module in communication with the presence information module,
wherein the presence information storage module is configured to store the dynamic presence information.

4. The system of claim 1, wherein the mobile communication device comprises:
a presence information communication module in communication with the presence information module,
wherein the presence information communication module is configured to communicate the dynamic presence information.

5. The system of claim 1, wherein the mobile communication device is configured to receive an information-query transaction from the user in response to the dynamic presence information displayed in the screen saver.

6. The system of claim 5, wherein the information-query transaction is configured to cause the presence information screen saver module to cease displaying the screen saver, and
wherein the information-query transaction is configured to cause the GUI display module to display information content at a network address associated with the dynamic presence information.

7. The system of claim 5, wherein the information-query transaction comprises a predetermined key sequence entered into an information input module of the mobile communication device.

8. The system of claim 1, comprising:
a presence information server in communication with the mobile communication device,
wherein the presence information server is configured to provide the dynamic presence information to the presence information module.

9. A mobile communication handset, comprising:
a display screen,
wherein the display screen is adapted to display information to a user of the mobile communication handset; and
mobile client application structure adapted to execute on the mobile communication handset,
wherein the mobile client application structure is in communication with the display screen, and
wherein the mobile client application structure comprises:
dynamic information content management structure,
wherein the dynamic information content management structure is adapted to manage dynamic information content associated with the user; and
dynamic information content screen saver structure in communication with the dynamic information content management structure,
wherein the dynamic information content screen saver structure is adapted to display the dynamic information content in a screen saver displayed on display screen.

10. The mobile communication handset of claim 9, wherein the mobile communication handset comprises:
information storage structure in communication with the mobile client application structure,
wherein the information storage structure is configured to store the dynamic information content.

11. The mobile communication handset of claim 9, wherein the mobile communication handset comprises:
information communication structure in communication with the mobile client application structure,
wherein the information communication structure is configured to communicate the dynamic information content.

12. The mobile communication handset of claim 9, wherein the mobile communication handset is in communication with a dynamic information content server, and
wherein the dynamic information content server is configured to communicate the dynamic information content to the mobile communication handset.

13. The mobile communication handset of claim 12, wherein the dynamic information content server comprises
dynamic information content preference management structure,
wherein the dynamic information content preference management structure is configured to manage user preferences for displaying the dynamic information content in the screen saver of mobile communication handsets.

14. The mobile communication handset of claim 9, wherein the mobile communication handset is configured to receive an information-query transaction from the user in response to the dynamic information content displayed in the screen saver.

15. The mobile communication handset of claim 14, wherein the information-query transaction is configured to cause the dynamic information content screen saver structure to cease displaying the screen saver, and
wherein the information-query transaction is configured to cause the display on the display screen of information content at a network address associated with the dynamic information content.

16. The mobile communication handset of claim 14, wherein the mobile communication handset comprises:
information input structure in communication with the mobile client application structure,
wherein the information-query transaction comprises a predetermined key sequence entered into the information input structure.

17. A method of displaying information to a user, comprising the steps of:
a.) receiving dynamic presence information associated with the user at a mobile communication device; and
b.) displaying the dynamic presence information in a screen saver on a display screen of the mobile communication device.

18. The method of claim 17, comprising the step of:
c.) managing the dynamic presence information associated with the user.

19. The method of claim 17, comprising the step of:
c.) managing user preferences for displaying the dynamic presence information in the screen saver.

20. The method of claim 17, comprising the step of:
c.) storing dynamic presence information for display in the screen saver.

21. The method of claim 17, comprising the step of:
c.) communicating the dynamic presence information for display in the screen saver.

22. The method of claim 17, comprising the step of:
c.) receiving an information-query transaction from the user on the mobile communication device in response to the dynamic presence information displayed in the screen saver.

23. The method of claim 22, wherein the information-query transaction is configured to cause the screen saver to cease being displayed, and
wherein the method comprises the step of:
d.) displaying information content at a network address associated with the dynamic presence information.

24. A method of displaying dynamic information content to a user on a mobile communication handset, comprising the steps of:
a.) receiving the dynamic information content associated with the user at the mobile communication handset;
b.) modifying the dynamic information content in accordance with display requirements of the display screen of the mobile communication handset; and
c.) displaying the modified dynamic information content in a screen saver on the display screen.

25. The method of claim 24, wherein step (b) comprises the step of:
d.) modifying the dynamic information content in accordance with user preferences.
